(19) United States
(12) Patent Application Publication
(10) Pub. No.: US 2003/0200192 A1
(43) Pub. Date: Oct. 23, 2003

(54) Method of organizing information into topical, temporal, and location associations for organizing, selecting, and distributing information

(76) Inventors: Brian L. Bell, Ithaca, NY (US); Srinivas Venigalla, Rochester, NY (US); Richard W. Page JR., Lansing, NY (US); Nathalie Gource, St-Bruno (CA)

Correspondence Address: MCKENNA LONG & ALDRIDGE LLP, 1900 K STREET, NW, WASHINGTON, DC, 20006, US

(21) Appl. No.: 10/124,296

(22) Filed: Apr. 18, 2002

(51) Int. Cl. G06F 7/00

(52) U.S. Cl. 707/1

(57) ABSTRACT

An event information processing method of processing event based information in an event information processing system for organizing and accessing event information includes steps of acquiring event based information from at least one information source, wherein event based information comprises attributes associated with topic, time, and location, and identifying topical, temporal, and location attributes from the event information that are used to organize the event information for selection and correlation with other event information. Topical, temporal, and location attributes are extendable by means of a topical hierarchical category resource, location and temporal hierarchical category resources or by application specific attribute information. The event information is storable in an event repository along with its topical, temporal, and location attributes. Event information is distributable to users authorized to access subsets of information, according to user specified or predetermined combined selection criteria of values, ranges or categories of topical, temporal, and location attributes.

### BACKGROUND OF THE INVENTION

1. Field of the Invention

The present invention relates to a method of organizing event based information by topical, temporal, and location attributes; along with selection and distribution of the event information by criteria based on values of those attributes.

2. Discussion of the Related Art

Throughout the ages, humans have devised ways to record, then examine, their thoughts and mental images on paper. People draw depictions of events, places, projects, and sets of objects. They chart scientific processes, demographics, weather conditions, and mechanical systems; and they diagram organizations, trade routes, music, and inventions. These drawings aid both the originator and subsequent audiences in picturing spatial or symbolic relationships. Paper drawings and maps, e.g., spatial data, are representations of the real world; but often the viewer must struggle to see only what is relevant amidst too much information. Transparent overlays can separate graphic information, but are cumbersome and restrictive. Reference documents such as catalogues, guide books, atlases, and encyclopedias gather together images and text descriptions, but the user must flip back and forth between pages to find, link, and compare information.

Computers are now being used to generate, compile, and retrieve such information and graphics. However, available methods have not as yet enabled viewers to smoothly call forth sets of graphic and textual data to inform and stimulate a sustained, multifaceted, analytical thought process. For example, computer programs that employ graphics layering are currently used to generate illustrations (computer graphics), drawings of designs, and searchable and thematic geographic maps.

Computer graphics may be used to draw lines and shapes that may be organized into layers for overlapping and for showing and hiding before being output as a printed or digital illustration. CADD (Computer-Aided Design and Drafting) is used to create plans of products, vehicles, buildings, utility systems, and other three-dimensional objects. CADD employs layering technology to draft and show different views of a three-dimensional object. A GIS (Geographic Information System) depicts data on a map with layers of points, lines, and polygons representing geographic features. Each geographic feature has a unique identifier, a set of coordinates (which may be real-world latitude and longitude) for positioning the feature, and attribute data describing the feature. A GIS provides functionality to analyze, query and display data.

These graphics-making programs are used primarily by trained technicians to produce a singular image for presentation and, in limited ways, for interactive analysis. However, non-technicians, e.g., the public, executives, and experts in non-computer fields, cannot easily use these programs to access and manipulate selections of coextensive data sets. Nor can they easily create or assemble their own sets of interactive, coextensive data sets.

GIS technology has come furthest in adding interactivity to spatial data. However, the basic functionality and tools are more inclined to produce desired graphic representations than multi-faceted analysis. Networked GIS is used within corporate and government intranets to provide staff access to spatial data and map products; it is also used on World Wide Web sites for the public to find a street address, directions, or the location of one particular facility or type of facility. In addition to searching for addresses and facilities, the interactive capabilities of current online GIS include zooming in and out and panning within a large digital map file.

Typically GIS is deployed to address a specific application or departmental function. The spatial data used in GIS are often static in nature and only updated on a periodic basis, making access to “real-time” data rare. Spatial data are often of different scales, projections, and origin making them difficult to integrate without intensive processing efforts. The current state of GIS technology does not adequately provide for seamless access to numerous subset combinations from coextensive data sets. Coextensive data sets, such as a description of events at or around a map location, are accessed by going to separate Web pages or windows. Through current technology the material is not viewed smoothly, in direct association with the map feature, thereby minimizing the value and use of the map.

Beyond layering software, another relevant computer technology is hypermedia. Hypermedia is the “linking” technology for instantly retrieving text, images, or sounds. Its “smart” graphics respond to commands such as mouse clicks to “hypertext” or to a “hot” symbol on the computer screen (often referred to as a button, object, icon, or image-map).

CD-ROMs and the World Wide Web are, at this time, the two predominant means of delivering hypermedia. For organizing and displaying material, these current hypermedia delivery methods use GUI (graphical user-interface) formats that are derivative. They draw from a combination of print publication equivalents, software document-creation conventions, and video presentation methods.

CD-ROMs were the first major application of hypermedia because of their vast storage capability for graphics and sound. These files are linked to create multi-dimensional games, training materials, and reference sources. Current reference CD-ROMS are organized to incrementally access graphic and text information on a single subject, but are not presently designed to enable comparison and to enhance prolonged, dynamic visual analysis.

The second major hypermedia application is the World Wide Web. Presently, the technology favors lengthy text over graphics, and graphics are commonly used as small link buttons and illustrations rather than as the core data set. While searchable GIS maps and e-commerce shopping sites are growing to be among the more popular image-intensive applications on the Web, the quality of their interactivity and usefulness for visual analysis and comparison is extremely low.

For example, the Web's current accepted practice of presenting material from information providers is based on a topically indexed, page-to-page metaphor related to print magazines. Location and time attributes associated with a particular topic are not differentiated from the topic because locations and times of a topical event are perceived as facts of the event. The magazine-like vertical layout requires the scrolling of the page to accommodate the horizontal orientation of the computer screen. The page is made up of magazine-like article, illustration, and ad components. The eye roams from component to component, viewing each separately. Text is often lengthy. To obtain additional information, hypertext, symbols, drop-down menus, or query forms are clicked to call up an entirely new Web page. Often the new material is at a different Web site with a different format. The viewer attempts, with minimal success, to carry in the mind's eye the sequence of information, links, and pages. The viewer must build a mental model of the findings of their inquiry, instead of having this accomplished for them on the computer.

It was this understanding and recognition of the problems with the prior art system that formed the impetus for the present invention.

### SUMMARY OF THE INVENTION

Accordingly, the present invention is directed to a method of organizing information into topical, temporal, and location associations that substantially obviates one or more of the problems due to limitations and disadvantages of the related art. The present invention allows cross referencing, selecting, and displaying composite information in any one or combination of a plurality of associations.

To achieve these and other advantages and in accordance with the purpose of the present invention, as embodied and broadly described, an event information processing method of processing event based information for distribution and display in an event information processing system includes the steps of acquiring event based information from at least one information source, wherein the event based information includes attributes associated with a topic, a time, and a location. The topic, time, and location attributes from the acquired event based information may then be identified either directly from the event information, or by inference from the source of the event information. In one embodiment of the present invention, the acquired event based information may then be stored in a database and indexed by the identified topic, time, and location attributes. Accordingly, the stored event based information may be displayed as event information reflective of a query dictated by search criteria comprising coextensive ranges of topic, time, and location. Selection criteria can be set according to predetermined values, from interactive specifications, or automatically augmented by correlated attribute values available from hierarchical sources for any or all of the attributes.

The event information processing method provides a utility for accessing all events regardless of whether their temporal attribute may be in the past, present, or future. This event information processing method allows processing past, present, and future event information from multiple sources to allow correlations whereas most information on events conventionally is not archived for later access.

The event information processing method herein described provides an efficient means to organize, select, and display global event information that may be relevant to a user. Event information, by definition, contains “what”, “when”, and “where” data. By creating associations and presenting each in an intuitive format, e.g., topic-listing, time-calendar, location-map, the user avoids the problem of irrelevant information with an easy selection mechanism. In one embodiment, user specified values of selection attributes may be augmented with correlated values of one or more of the selection attributes to provide relevant additional event information.

The event information processing method provides public distribution of event based information by topical, temporal, and/or geographic associations for any event type or geographic scale over the Internet or various other display devices. The method provides a means whereby event based information subsets can be derived based on associations of cross referencing and querying information by topic, time, and location. The method provides a unified means to promote future events, identify current events, and provide access to historic events. The method provides a research means to establish cross referencing of event based information by topic, time, and/or location to identify patterns, trends, and other behaviors. The method provides a means to continually ingest event based information to provide event information updates to a diverse audience of information consumers and to support decision making.

The method provides a means for organizations to securely distribute event information to a predefined user group in a meaningful way.

The method provides a means to identify a value chain of users based on the topical, temporal and/or geographic parameters of the event information accessed or viewed by them, selected by one or more associations of topic, time, and location.

The method includes processing of location indicators such as mail code (zip), street addresses, or intersections to geographic locations and extents by use of geo-coding engines, translations of geographic proper nouns to geographic locations and extents by use of a gazetteer, with the option of extending these reference sources by adding geographic sources for additional countries, third party provided information of standard geographic translations or alternate types of geographic information such as sales territories, school districts, or the like. The method also provides for tallying the occurrence of geographic proper nouns encountered in event information not contained in the gazetteer to prioritize gazetteer extension activities, and similarly for other geographic reference translations to locations.

The method further includes extending the location attributes determined for an event to include a position, any applicable spatial extent, and any hierarchical location types correlated to the event location. Thus while an event will be held at specific location, for example Grant Park, it will be correlated with the geographic location of Grant Park as well as with Chicago and Illinois.

The method includes recognition of temporal information in a variety of formats, translation to a universal time for correlation, and correlation of the event with applicable time categories such as time of day, day of week, month, year, century. For specific applications additional time categorizations may be added, for example geological eras, or sales campaign time periods.

The method includes processing topical indicators from the event information by comparison to the topical hierarchical category reference source. The topical attribute for the event will include any match found from the event information in the topical reference source as well as all topics correlated with it in the hierarchical topical category reference source. The method also provides for tallying the occurrences of topic references from event information not found the topical hierarchical reference source to prioritize topical reference source extension activities.

Uses of the invention include its incorporation as a spatial-temporal knowledge agent/system to ingest, organize, and distribute information as part of in-car navigational systems, intelligent transportation systems, mobile communication devices, personal digital assistants, corporate competitive intelligence applications, and other artificial intelligence applications.

In one embodiment of the present invention, event information may be viewed where the location criteria of the query may be set by a location defined by a global positioning system (GPS), network based triangulation, e.g. as required by the FCC for cell phones, or any other automated location determination that can be transmitted for use in processing. Either the exact transmitted location can be used as a location selection criterion, or some spatial extent around the transmitted location can provide search criteria for the location attribute.

The event information processing method is not restricted to geographic locations but can be applied to organize information by any specified spatial dimensionality on any scale from astronomical to subatomic. Spatial translation information can be used to translate diverse types of location indicators instead of or in addition to geographic locations, such as material, medical, architectural, chemical or engineering based spatial reference systems.

If the spatial system being utilized is geographic, the method can incorporate geographic locations, with or without reference to elevation. The method can organize information on either a limited geographic scale serving one location, or can offer event information on a global scale.

For a specific application, alternate attribute types may be defined to allow identification and determination of such alternate attributes for acquired event information in addition to, or instead of one or more of the topical, temporal, and location attributes. For example in a system tracking sales force performance events, additional attributes to be identified might include dollar sales totals as reported, or as percentages of sales quotas by region, team, or sales representative.

The process according to the present invention enables users to indulge in cross interests at multiple locations, which may require information gathered and processed from several sources. The event information processing technology of the present invention is targeted toward serving the needs of users who require not just information, but a way of accessing relevant information when and where they need it.

An advantage of the present invention is that it can provide a means for public distribution of event information by topical, temporal, and/or location associations for any event type or geographic scale over the Internet and various other distribution devices including, for example, any PC connected to the Internet, an intranet, a personal virtual network (PVN), or any email system, any other device connected to these systems such as a personal digital assistant (PDA), visual display device, wireless or wire-based telephonic device, e.g. telephone, cell phone, fax, and the like.

Another advantage of the present invention is that it provides a means whereby event based information subsets can be derived based on associations cross referenced by topic, time, and location, either single values, ranges, or categories of any or all of those attributes. In an embodiment of the invention, attribute selection criteria and event display may be accomplished through an interactive web-based user interface with a selection/display window for each attribute and an enhanced display based on one attribute according to user specification. The attribute windows allow users to select values or ranges of any or all of topics, times and location specifically or by interaction with the display in an attribute window. For example times may be selected either by marking dates on a calendar or by typing a date reference in the temporal attribute window; topics may be selected by typing words or phrases or by selecting from lists of topics arranged hierarchically in the topic attribute window; location selection may be set by typing a street address, intersection, geographic proper noun or by zooming or panning on a map displayed in the location attribute window. Displayed events will be reflective of the combination of search criteria set by the user. The geographic display will be correlated with displayed events by display type and scale from information in the geographic reference source; it may be a relief map, a street map, an aerial photograph, a floor plan diagram, or any other location display available from public sources or provided for specific applications.

Displayed event information text may have geographic hyperlink extensions associated with any geographic proper noun. Selecting such hyperlinks may reset the location attribute window display, and provide an additional means of setting location attribute selection criteria.

Among advantages of the present invention may be that it provides a unified means with which to promote future events, identify current events, and provide access to historic events. It provides information for data mining research means to establish cross referencing of event based information by topic, time, and/or location to identify patterns, trends, and other behaviors.

It provides means to continually ingest event based information, provide event information updates to a diverse audience of information consumers, and to support decision making. The method allows acquisition of event information by means of direct feed, harvesting publicly available sources of event information, direct access to event information or manual entry of event information to the system by web or other form, voice recognition conversions, from audio, video, multimedia formats, or any other source of event information that is perceptible. In an embodiment of the invention event information may be ingested from sources in formats ranging from Extensible Markup Language (XML), Hypertext Markup Language (HTML), News Industry Text Format (NITF), Wireless Markup Language (WML), and Rich Text Format (RTF) to standard multimedia formats, data exchange formats, delimited, plain text, and the like.

In one embodiment of the present invention, the user interface may also comprise a submission interface enabled for registered users to submit, manage, and distribute event information.

The present invention provides a means with which to identify the topical, temporal, and/or geographic area associated with event information being accessed/viewed by a user and supply a corresponding advertising message based on one or more of the associations, i.e., geo-temporal contextual advertising.

Another advantage of the present invention provides a spatial-temporal knowledge agent/system to ingest, organize, and distribute information as part of in-car navigational systems, intelligent transportation systems, mobile communication devices, personal digital assistants, corporate competitive intelligence applications and other artificial intelligence applications.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate aspects of the invention and together with the description serve to explain the principles of the invention.

In the drawings:

FIG. 1 illustrates an infrastructure according to the present invention;

FIG. 2 generally illustrates a process flow according to the present invention;

FIG. 3 illustrates the process flow of the TTL indexing in the event information processing method according to one embodiment of the invention;

FIG. 4 illustrates the process flow within the database logic in the event information processing method according to one embodiment of the invention;

FIG. 5 illustrates the process flow within the pre-presentation logic in the event information processing method according to one embodiment of the invention; and

FIG. 6 illustrates a user interface in accordance with an embodiment of the present invention.

### DETAILED DESCRIPTION OF THE ILLUSTRATED INVENTION

Reference will now be made in detail to the principles of the present invention, examples of which are illustrated in the accompanying drawings.

In an embodiment of the present invention, an event information processing system of processing event based information for distribution and display in an event information processing system includes a database and associated software for acquiring, indexing, storing, and retrieving event based information. The event based information may be characterized by topic, time, and location attributes. Display means may be provided which are capable of displaying the event based information. The event based information may be displayed as event information reflective of a query dictated by search criteria comprising coextensive ranges of topic, time, and location.

The method includes acquiring and organizing information into topical, temporal, and location associations, including applying semantic rules for parsing textual event based information to develop at least these three associations. Information may be acquired and processed in real time, from a delayed feed, or from archived sources. A user interface provides a means for viewing, cross referencing, querying, and displaying information in one or more combinations of the three associations. The method according to the present invention may be extended to include predefined user selections of specified topics, time ranges, and locations. The method may be invoked by and distributed to personal computers having visual display systems, Internet, Intranet, e-mail, PDA, and other wireless or wired devices. Additional information, including pictorial representations, may be ingested, archived, and retrieved for display or distribution by any of the three associations.

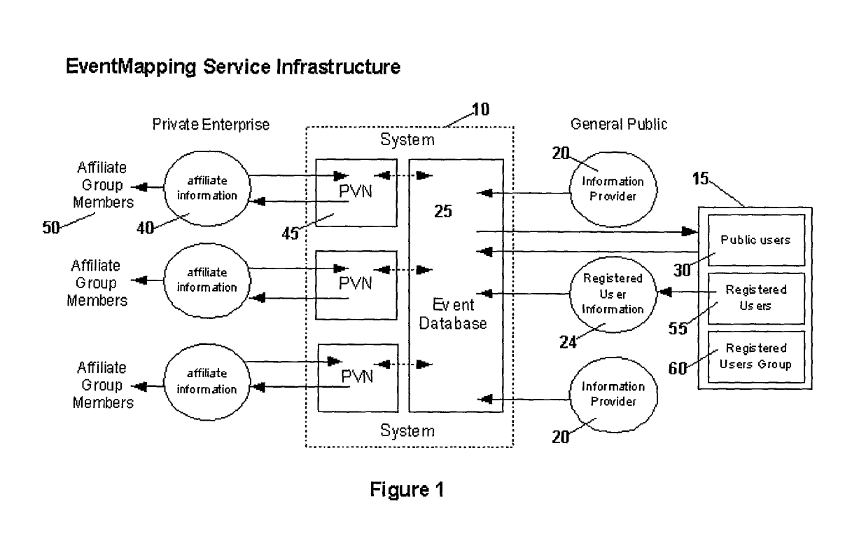

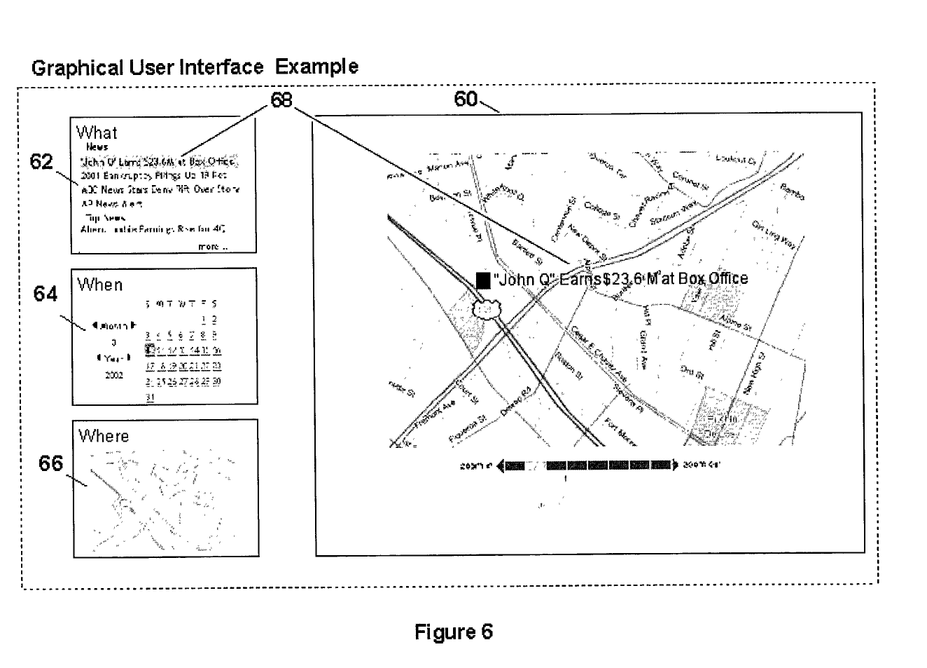

As generally shown in FIG. 1, one embodiment of the present invention comprises an event information processing system 10 which may be an internet accessible service that provides event information to users 15 employing an event information processing method. Generally, an event constitutes something that happens; a noteworthy happening; a social occasion or activity. Alternately, an event may also be described as being the fundamental entity of observed physical reality represented by a point designated by three coordinates of place and one of time in the space-time continuum postulated by the theory of relativity, or any information that contains topical, temporal, and location references, with or without correlated data. The event information can be textual, numerical, graphical, or other content that can be correlated and organized by associations according to attributes of topic, time, and location or other attributes and may be viewed on the basis of a users' event viewing authorization. Public event information 20 may be ingested and organized from public information providers into an event database 25 based on associations of the three attributes of topic, time, and location and any additional attributes and made available to public users 30. As will be discussed in greater detail below with reference to FIG. 6, a user interface allows users to query, cross reference, and view event information in one or more associations of the attributes as ingested and organized. Like public users, registered users 55 may view event information through the user interface, but may also preset event viewing preferences including event query attributes and distribution modes. Registered users may submit event based information 24, e.g., data containing a topic, time, and location, into the event database for distribution, designating public distribution or distribution to members of a specified registered users group 60. Affiliate event information 40 may be entered into a private virtual network (PVN) 45 by an affiliate administrator or other information provider, organized by specified attributes, and released to the event database for distribution to a group of predetermined users or to affiliate members 50.

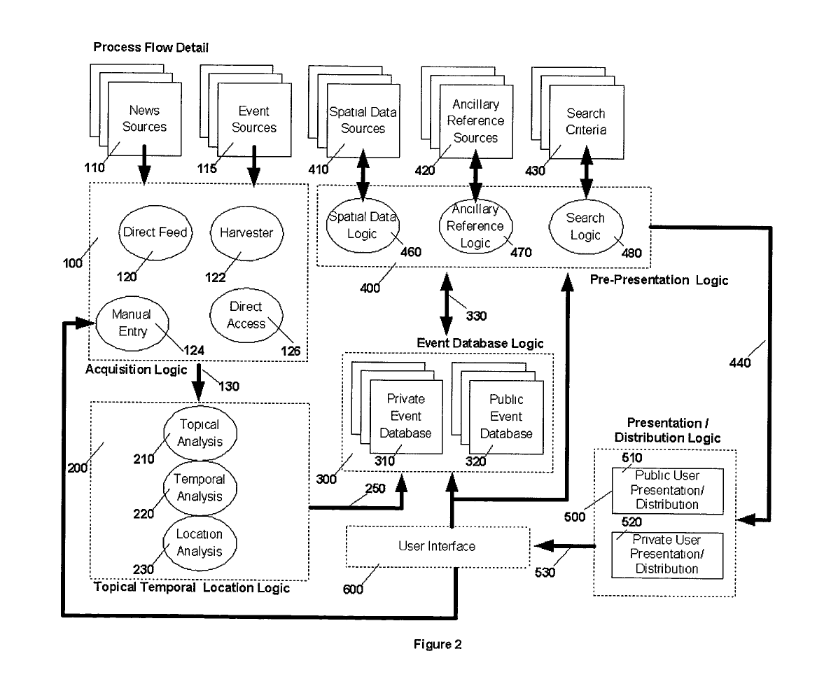

As shown in FIG. 2, a more detailed description of the process outlined in FIG. 1 will now be discussed.

In order to ingest and organize event information, the information must first be acquired using acquisition logic 100. Acquiring content from information providers such as news sources 110, e.g., organizations that feed event based information structured in a journalistic format, and other event sources 115 may be accomplished through the use of direct feeds 120, harvesting technology 122, manual entry of event based information 124, or acquisition of event information by direct access to existing repositories 126. For example, direct feeds include automated processes having means for ingesting affiliate supplied formatted event based information into an event database based on established communications protocols and defined formats. Harvesting is a process having means for automatically capturing event based information from a known source and ingesting it into an event database.

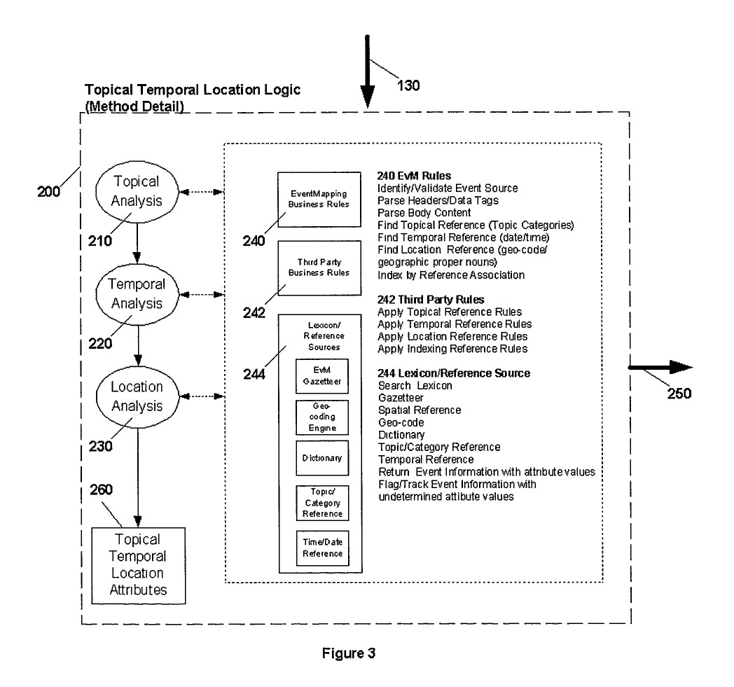

Using TTL (Topical, Temporal, and Location) logic 200, lexical and semantic rules may be employed to parse acquired textual information or process other formats 130 to find topic 210, time 220, and location 230 attributes of the information for organizing, querying, cross referencing, distribution, and display. Attribute values for each event may be determined from event content, source and additional correlations, as will be discussed in greater detail below with reference to FIG. 3.

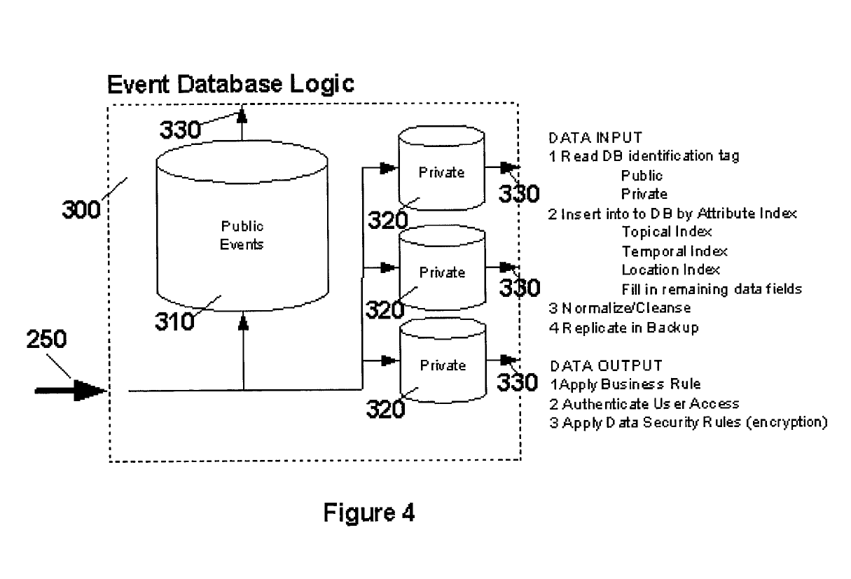

After the acquired information 130 has been TTL analyzed, the information 250 may be formatted and stored as event information in an event database using event database logic 300. The information, indexed by topic, time, and location attributes, may be stored either in a public event database 320 or in a private event database 310, depending on an event viewing authorization of the event based information. The event database logic checks what information is accessible to what types of users, e.g., public, private, predefined group, etc. Additionally, the database logic includes processes to store, retrieve, archive, and protect the event information as will be discussed in greater detail below with reference to FIG. 4.

Event information selected from the Event Database 330 may then be augmented using Pre-presentation Logic 400. This pre-presentation processing submits Search Criteria 430 to the Search Logic 480 to control retrieval of event information from the Event Databases, processes the topic, time, and location attributes of the retrieved information using Spatial Data Logic 460 and Ancillary Reference Logic 470 to provide additional information correlated to the events. Accordingly, event information may be processed to incorporate corresponding ancillary information, e.g., maps or other spatial images from Spatial Data Sources 410, text, graphics, multimedia information, marketing material such as logos or headers from Ancillary Reference Sources 420, event based advertisements provided by ad sources and managed by ad logic (incorporated into Ancillary Reference Logic 470), all reflective of attribute elements from Search Criteria 430 that have been manually or internally set. The spatial data, graphics, and advertisements may be periodically updated by the event information processing system using various spatial data, graphics, and ad logic components.

Retrieved event information 440 comprising at least one of the results of attribute search criteria matches, along with ancillary descriptive information and spatial data may then be output to the presentation/distribution logic 500. The presentation/distribution logic distributes the retrieved information to predetermined user(s) in predetermined format(s) based on public user 510 or private user 520 preferences. Private user presentation preferences, modes, and authorizations can be set individually by registered users or by affiliate administrators for their affiliate members.

Users may view event information that is selected by topic, time, and location. Registered users may preset preferences that identify which event information is relevant by topic, time, and location. Affiliate administrators and registered users may identify how the event information will be distributed and on what recipient devices. “Event Alerts” may be created and distributed by event promoters to users based on user preferences and recipient device selection, employing push technology. Accordingly, event promoters may identify event information for distribution to users or groups of users based on topic, time, location, or third party business rules.

Distribution of the information may be predefined in either the internal or third party business rules. The business rules state how the event information may be formatted and distributed throughout the value chain. The business rules contain an identification of the type of display device, e.g., computer, wireless device, etc., on which the information is to be presented. Accordingly, the presentation/distribution logic in the event information processing system converts or translates information for distribution.

If the event information is to be distributed through user interface 600, the event information 530 may be formatted for display. The user interface includes a graphical user interface (GUI) and provides all the navigation, query, and viewing tools for interacting with the event information resident within the event database, as well as a means for registered users to enter event data into the event database. An example of an internet accessible GUI will be discussed in greater detail with reference to FIG. 6.

Referring to FIG. 3, a more detailed explanation of the attribute analysis and indexing process within the topical, temporal, location (TTL) logic may be as follows. Rule-based and lexical parsing of information may be employed in analyzing ingested information by attributes, for example, topic, time, and location (TTL attributes) 260 to organize event information. As information 130 is ingested, each word or group of words may be analyzed by a set of business rules and lexical analytic tools. The business rules filter and index event information from ingested information 130. TTL analysis may use internal event information processing business rules 240 and third party business rules 242 to organize event information. Portions of event information processing internal rules may be modified by any third party business rules to determine how event information supplied by an affiliate may be ingested, classified, categorized, organized, stored, distributed, and presented. In order for the event information processing method to accept third party business rules, certain information must be provided to the event information processing method including, for example, 1) the format of the information to be ingested; 2) the third party business rules, e.g., event information distribution, presentation, etc., to be applied; and 3) the relevant topic, time, and location references, e.g., lexicons or resources.

The ingest format allows the event information processing method to efficiently parse ingested information. In cases involving harvested information or direct feeds from third party affiliates, e.g., news sources such as AP and Reuters, the ingest format may be XML. However, other ingest formats such as HTML, plain text, character delimited text, and direct access of database fields may also be used. Manual entry of event information may be submitted by registered users in, for example, HTML format using a submission form provided by the event information processing system. Headers and data tags may be parsed as an initial filter of the information. From the headers and the data tags, keywords may be discerned to validate the source of the information and to create general categories for referencing and indexing. The internal business rules 240 may then be applied to further segment the information into more specific categories. Once the headers and data tags have been processed, the body of the content may be addressed.

An example of an internal business rule set 240 to be applied to event based information to be ingested into the event database maybe as follows: 1) Identify/validate the source of information and information format; 2) Parse information headers and data tags using known data formats; 3) Analyze headers and data tags for topic, time, and location references; 4) Apply topical word search by cross referencing a topical category reference and dictionary within Lexicon/Reference Source 244 (see below); 5) Index topical words by hierarchy of topical category reference in Lexicon/Reference Source 244 (see below); 6) Apply time/date processing, e.g., Year/Month/Day and/or Hour/Minute/Second, by cross referencing the time/date category reference in Lexicon/Reference Source 244 (see below); 7) Index the time/date with Greenwich Mean Time and/or by hierarchy within time category reference in Lexicon/Reference Source 244 (see below); 8) Apply location search of geographic proper nouns and addresses by cross referencing geographic proper nouns with a gazetteer or geo-coding addresses in Lexicon/Reference Source 244 (see below); 10) Index geographic locations by longitude/latitude and/or by hierarchy within location category reference in Lexicon/Reference Source 244 (see below) for spatial data retrieval; and 11) Create Geographic Hyperlink Extension (GHE), as will be discussed in greater detail below.

During step 242, any third party business rules may be applied to event information submitted by means of the direct feeds. Accordingly, topical, temporal, location, and additional attributes may be determined by the business rules of the third party.

According to the present invention, the parsing technique used at step 240 includes a geographic context recognition system containing a geographic proper name solver which processes geographic names using a variety of techniques, including, for example:

1. Looking for any capitalized letter immediately after a white space or a punctuation mark. Treating the capitalized letter as the first letter at the beginning of a proper noun, as first letters in all geographic proper nouns are capitalized in English.

2. Collecting all letters up to the next white space or punctuation, starting with the first letter of the proper noun. Determining whether the collected letters are part of a geographic proper noun and checking the proper noun in a gazetteer to find the latitude/longitude of the proper noun, e.g., “Rochester”, “Rochester.”, etc. Accordingly, the gazetteer includes a dictionary of geographic proper nouns and their associated geographic location or area, e.g., an area bounded by a specified range of latitude and longitude, or contained within specified contiguous map cells.

3. Recognizing that a proper noun could also be a word all capitalized, e.g., NASA, proceeding to the next white space/punctuation.

4. Determining whether all of the letters within the proper noun are capitalized and, if they are filter the them against a library of acronyms and eliminate it if found, e.g., PTA.

5. Determining whether the proper noun is all capitalized and ends with a white space and looking for the first letter after the white space. Determining if the first letter after the white space is lower case and, if so, considering it as the end of the proper noun, e.g., “Rochester is”.

6. Determining if the letter after the white space is capitalized, and taking the next whole word(s) as part of the noun, e.g., La Guardia Airport. Such nouns are called phrasal nouns.

7. Determining if the punctuation immediately after the noun/phrasal noun is a comma, then taking that word and checking if the next word/phrase is a state (e.g., “Rochester, N.Y.” or “New York, N.Y.”), and finding its location using the gazetteer, a resource correlating geographic proper nouns with locations.

In accordance with one embodiment of the invention, the gazetteer may be extended by tallying and reporting, by frequency, the geographic proper nouns that are not present in the gazetteer. In so doing, the missing geographic proper nouns and their corresponding geographic locations may be entered into the gazetteer, prioritized by the frequency of missing geographic proper noun occurrences.

The topical word searches may be lexical and semantic, using word identification and the meaning of the language. A semantic application may include word selection that means a positive business circumstance, e.g., an increase in profits, increase in market share, growth industry, etc. A lexical search method such as a search for business executives may use a specific list, e.g., “Bill Gates”, “Jaques Nesser”, “Lou Gerstner”.

A topical attribute business rule could be as simple as: find all event information containing ‘George W. Bush’. More complex business rules may contain many identifiers and actions, and may even be based on artificial intelligence. For example, a financial institution may have an indicator based on semantics that include a positive change in the market, e.g., increase, rise, profits, for all event information within the category of “Business” located in “New York”. Then for all of those cases that meet the criteria, another set of business rules may be applied, e.g., cross reference to identify content that includes competitor companies, where a list has been provided. Additionally, patterns and trends may be used to trigger distribution business rules, e.g., if the number of times “Pepsi” is found in the news exceeds 3, generate an event alert notification to the marketing division.

Topical attribute analysis includes correlating topics found in the event information with additional topical attribute values from the topical hierarchical reference sources. The following is an example topic lexicon, i.e., topical event category hierarchy structure that maybe applied to news and scheduled events:

1) News Event Information Hierarchy

a) Top Stories

b) World News

c) Local News

d) Business

e) Technology

f) Politics

g) Entertainment

h) Sports

i) Science

j) Health

2) Scheduled Event Information Hierarchy

a) Sports

i) Professional

ii) Collegiate

iii) Local

(1) Baseball

(2) Basketball

(3) Hockey

(4) Lacrosse

(5) Football

(6) Swimming

(7) Tennis

(8) Soccer

(9) Field Hockey

(10) Softball

(11) Volleyball

(12) Track and Field

(13) Bicycling

(14) Racing

b) Antiques/Collecting

c) Recreation/Leisure/Hobbies

i) Aerobic/Fitness

ii) Camping

iii) Fishing

iv) Golf

v) Hiking

vi) Skiing

vii) Bird Watching

viii) Walking

ix) etc.

The above topical category lists may evolve as additional event information is acquired in a similar manner as described above with respect to the gazetteer. User queries may search based on the primary topical categories, but may also use the lower level hierarchical associations. In one embodiment of the invention, a hierarchical, toggle-based, topical category list may be presented at the user interface to facilitate the topical attribute search.

A time/date category hierarchy, top level to bottom level, may be as follows: millennium, century, decade, year, quarter, month, week, day, hour, minute, second. Other time/date hierarchies may be added to accommodate specific applications, e.g., geologic eras, historical eras, fiscal years, product life cycles, business events, etc. When querying, the user may express a sequential range or numerous specific times, e.g., from 10/12/01 to 10/31/01, or 10/12/01, 10/15/01, and 10/31/01. User queries may search based on the primary temporal criteria, but may also use lower level hierarchical associations. In one embodiment of the invention, a calendar/clock may be presented at the user interface to facilitate the temporal attribute search. The time/date category hierarchy may be enhanced, e.g., other time/date categories may be added as event information is acquired, in a similar manner as described above with respect to the gazetteer.

A location category hierarchy, top level to bottom level, may be as follows: world, hemisphere, continent, country, territory/region, province/state, zip code/postal code, place name/city, neighborhood/district, address range/block, street address, point location. Other geographic boundaries and features may be added to accommodate specific applications, e.g., sales territories, media markets, political boundaries, etc. Additionally, buffers and distance factors may also be used in selection processes, e.g., a 10 mile radius from a location. User queries may search based on the primary location criteria, but may also included hierarchical location associations. In one embodiment of the invention, an interactive map and pull down menu may be provided at the user interface to facilitate the location attribute search. The location category hierarchy may be enhanced, e.g., other location categories may be added as event information is acquired, in a similar manner as described above with respect to the gazetteer.

The parsing and business rules may be applied for every topic, time, and location reference in each ingested event. For all business rules used, supporting lexicons and conditions must be included.

Ingested event information that is successfully analyzed to yield values for the specified attributes may be returned as indexed while event information for which the attribute analysis fails to provide values is not indexed. These events that cannot be indexed may then be flagged and tracked through the event information processing method.

As shown in FIG. 4, the event database logic indexes the event information 250 by topic, time, and location according to attribute values determined in the TTL logic and determines whether the data may be for use with private affiliates or public users. Next, the information may be given an event title and stored within private or affiliate event databases 320 or the public event database 310 according to its topical, temporal, and location attribute indexes. The process then proceeds typically as in a relational database management system (RDBMS) for normalizing, eliminating duplicates, and employing back up processes. The data output 330, e.g., the event information from the event database, may be available in response to a query by a user or according to internal or third party business rules for data distribution and according to event viewing authorization of each event entry. In all cases, however, authentication of the user, in addition to other security measures, e.g., firewall, encryption, may be performed to ensure the integrity of the data in both types of database, 310 and 320.

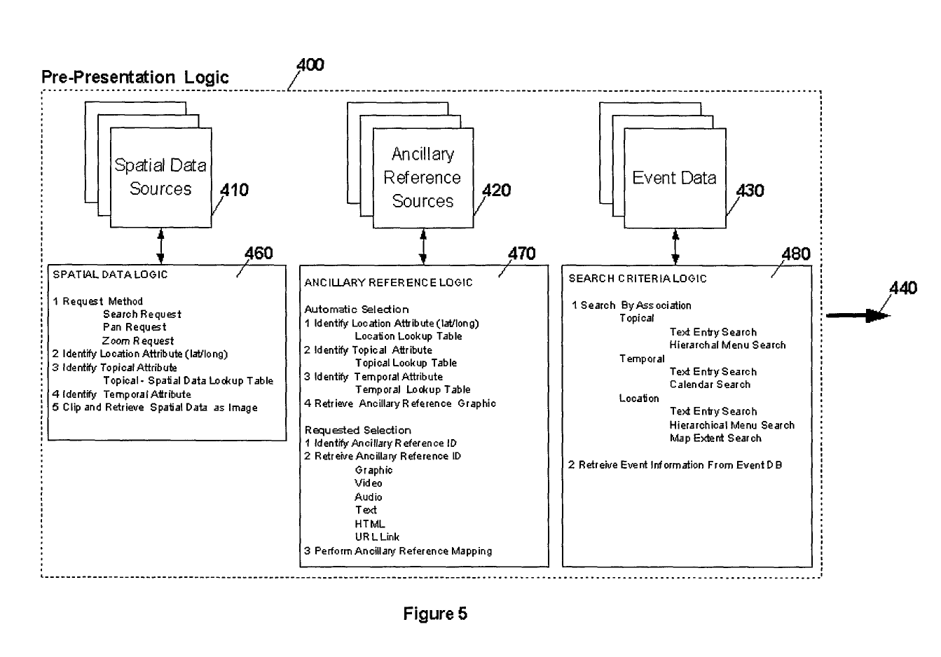

Event information selected from the event database 330 may then be processed by pre-presentation logic as depicted in FIG. 5. Three main process components determine what may be presented to the user. The components include: 1) spatial data logic 460; 2) ancillary reference logic 470; and 3) search logic 480.

In this example for event data to be displayed, the spatial data logic 460 generates a spatial data set, e.g., map or other location graphic, from a spatial data source 410 that may be chosen to represent selected location attributes of the data output 330 by type and scale. The spatial image may be displayed for the user with the event information. Accordingly, the spatial data set may be based on theme and scale, i.e., spatial resolution, and reflects the location hierarchy. For time sensitive events, the spatial data set may also be based on temporal resolution. Spatial data within the spatial data sources may be referenced by latitude and longitude. For locations that cannot be identified by latitude and longitude, other location identifying data may be referenced. Spatial data source selection may be responsive to any search, pan, and zoom requested by the user explicitly or by interaction with a spatial data image displayed in the GUI. The spatial data sources thus create a selected spatial data set by identifying the location attribute, e.g., the latitude/longitude, elevation, extent; the topical attribute using a topical-spatial data lookup table; and the temporal attribute within a user query. Once the selected information is identified, the spatial data source processing selectively clips and retrieves spatial data from the spatial data library as an image for presentation to the querying user.

The ancillary reference logic 470 generates selected topical/temporal/location ancillary descriptive information from ancillary reference data sources 420 correlated to one or more of the three attributes within the selected data output 330. This ancillary information may be distributed to the user to provide further information, relevancy, or reference to an event displayed as a result of a user query. Ancillary descriptive information may be generally defined as graphics, animation, text, video, hyperlink, or pictorial representation and may be organized by the same TTL categories present within the event database. The ancillary descriptive information may be presented in the GUI in a separate window. The ancillary reference source display may be enabled automatically or may be optionally selected by the user to display ancillary information correlated to the current event displayed. In automatic mode, the ancillary reference source process creates a selected ancillary reference data indicator by identifying the location attribute, e.g., the latitude/longitude in a location lookup table; the topical attribute in a topical lookup table; and the temporal attribute using a temporal lookup table. Once the attribute information is identified, the ancillary reference source process selectively retrieves ancillary reference data from the ancillary reference data library. In user selection mode, the ancillary reference source creates the ancillary reference data indicator by identifying previously specified TTL attributes and retrieving the ancillary reference data, which may include any of the following: graphics, video, audio, text, HTML, or URL link. Ancillary reference mapping, e.g., creation of location references, may then be performed, as will be discussed in greater detail below. Correlated geographic locations may be displayed as map icons/symbols representing locations of the referenced ancillary information.

All proper noun location references may be identified by a geographic hyperlink extension (GHE), a linkage that retrieves a map or other spatial image correlated to the reference from a spatial data library.

In the present example, search criteria 430 maybe selected to structure a query that searches the event database by topic, time, and/or location attributes. The event information responsive to the search criteria is the event data output 330. The query may be performed against each attribute independently, but results of the query are dependent on the other attributes. The aforementioned hierarchical indexes allow a range of topical, temporal, and location themes of event data within the event database to be queried providing event data output. Additionally, the event data may be searched via text, voice or pre-selected attribute specifications.

As shown in FIG. 6, according to one embodiment of the invention where query criteria may be set in a GUI, the location attribute may also be searched using spatial data, as determined by location and extent of a map display, for example. The query results may be displayed based on the attribute search criteria. Each match may be identified as meeting 3 out of 3 criteria, 2 out of 3 criteria, or 1 out of 3 criteria. Those results meeting all three attribute search criteria may be displayed at the top of a matched results list. Furthermore, any one or all of the search criteria ranges may be adjusted at any time to alter the event information displayed. Full Boolean search criteria may be applied.

In one embodiment, the graphical user interface (GUI) 600 comprises a “3V Format” (3V for three views) and displays each of the three attributes: topical 62, temporal 64, and location 66, in separate windows, or views, while also displaying a primary window 60 to provide a framework for the user to navigate event information. Topical view 62 presents topic selection options and allows for topic hierarchy selections and event presentation. Temporal view 64 presents time selection as date or dates from calendar pages and presents events organized by time. Location view 66 presents location selection often geographically as a map cell encompassing a specified location, address, or area connoted by a geographic proper noun upon which event information may be presented and organized. Accordingly, the association of the three attributes may be simultaneously displayed as smaller windows next to the larger primary window. Each attribute window provides the user with the ability to query ranges of information specific to topic, time, or location. As the parameters of the search criteria change, the event information may be updated and displayed in the attribute windows and in the primary window. The primary window replicates any one of the three attribute windows in a larger format and contains more detailed information than what is displayed in the corresponding attribute window. Any of the three attribute windows may be selected as the primary window display by the user.

Events meeting user specified search criteria for attribute values may be displayed in each window. For example, an event list corresponding to event designations 68 may be displayed in the topic window 62. Event designations 68 may also be displayed according to their location attribute on the location display graphic or map in the location window 66, or on the calendar displayed in the temporal window 64.

The user interface displays geographic hyperlink extensions (GHE) links which were created as described above for all geographic proper nouns found in selected event content by the pre-presentation logic. When selected, the GHE accesses the spatial data library containing maps, aerial photographs, satellite images, and other spatial data, and presents applicable links within the location map. Subsequently, the GHE makes available additional text or graphic information related to an event correlated to a region in the map.

It will be apparent to those skilled in the art that various modifications and variation can be made in the present invention without departing from the spirit or scope of the invention. Thus, it is intended that the present invention covers the modifications and variations of this invention provided they come within the scope of the appended claims and their equivalents.

What is claimed is:

1. An event information processing method of processing event based information in an event information processing system, comprising:
acquiring event based information from at least one information source, the event based information having topical, temporal and location attributes;
determining topical, temporal, and location attributes from the acquired event based information; and
organizing the event based information by the determined topical, temporal, and location attributes,
wherein the event based information is accessible as event information reflective of criteria comprising values of topical, temporal and location attributes.

2. The event information processing method of processing event based information according to claim 1, wherein the event based information is acquired by at least one of a direct feed, a harvesting, a direct access or manual entry of event based information.

3. The event information processing method of processing event based information according to claim 1, wherein the format of the acquired event based information is at least one of: text, audio, video, graphic, multi-media, signal reception, sensory information or machine perceptible information formats.

4. The event information processing method of processing event based information according to claim 1, wherein the format of the acquired event based information is predetermined from the source of the data.

5. The event information processing method of processing event based information according to claim 1, wherein attributes of topic, time, or location are determined from explicit references within the acquired event based information.

6. The event information processing method of processing event based information according to claim 1, wherein attributes of topic, time, or location are determined implicitly from the source of the acquired event based information.

7. The event information processing method of processing event based information according to claim 1, wherein the step of determining the location attribute further comprises converting the location attribute to at least one of a spatial extent and a point location.

8. The event information processing method of processing event based information according to claim 1, wherein the step of determining the location attribute further comprises converting the location attribute to at least one of a geographic area and a geographic location.

9. The event information processing method of processing event based information according to claim 1, wherein the location attribute comprises a street address or a street intersection, the method further comprising:
converting the street address or street intersection to at least one of a geographic area and a geographic location.

10. The event information processing method of processing event based information according to claim 1, wherein the location attribute comprises a spatial reference that has spatial location and extent available through an application specific spatial reference source.

11. The event information processing method of processing event based information according to claim 1, wherein the location attribute comprises a geographic proper noun, the method further comprising:
converting the geographic proper noun to at least one of a geographic area and a geographic location using a spatial reference source.

12. The event information processing method of processing event based information according to claim 11, wherein the spatial reference source is extendable, the method further comprising:
tallying and reporting, by frequency, geographic proper nouns or other spatial references not present within the spatial reference source; and
adding missing geographic proper nouns or other spatial references and their corresponding spatial locations and extents into the spatial reference source.

13. The event information processing method of processing event based information according to claim 1, wherein the topic attribute comprises topics from the event information found in the topical hierarchical reference source and additional topics connected to them in the topical hierarchical reference source.

14. The event information processing method of processing event based information according to claim 13, wherein the topical hierarchical reference source is extendable, the method further comprising:
tallying and reporting, by frequency, topical references not present within the topical hierarchical reference source; and
adding missing topical references and their hierarchically connected references into the topical hierarchical reference source.

15. The event information processing method of processing event based information according to claim 1, wherein the topical attribute comprises topical references available through an application specific hierarchical topical reference source.

16. The event information processing method of processing event based information according to claim 1, wherein the temporal attribute further comprises cross references of the temporal attribute from the temporal hierarchical reference source.

17. The event information processing method of processing event based information according to claim 16, wherein the temporal hierarchical reference source is extendable the method further comprising:
tallying and reporting, by frequency, temporal references not present within the temporal hierarchical reference source; and
adding missing temporal references and their hierarchically connected references into the temporal hierarchical reference source.

18. The event information processing method of processing event based information according to claim 1, wherein the location attribute further comprises cross references to the location attribute from the location category hierarchical reference source.

19. The event information processing method of processing event based information according to claim 18, wherein the location category hierarchical reference is extendable, the method further comprising:
tallying and reporting, by frequency, location category references not present within the location category hierarchical reference source; and
adding missing location category references and their hierarchically connected references into the location category hierarchical reference source.

20. The event information processing method of processing event based information according to claim 1, wherein the acquiring, organizing, distributing and portraying of the event information is controlled by a set of event information processing rules, a portion of which, are supplementable with processing rules supplied by a third party.

21. The event information processing method of processing event based information according to claim 1, wherein the event information is distributable by at least one of an email system, a personal digital assistant, personal computer, wireless device, wire-based communications device, and a visual display system for display.

22. The event information processing method of processing event based information according to claim 1, wherein the event information is selectively distributable to users having an event information access authorization.

23. The event information processing method of processing event based information according to claim 1, wherein topical, temporal, and location selection criteria for event information distribution are set by user's predetermined preferences.

24. The event information processing method of processing event based information according to claim 1, wherein topical, temporal, and location selection criteria for event information distribution are determined by third party supplied rules.

25. The event information processing method of processing event based information according to claim 1, wherein topical, temporal, and location selection criteria for event information distribution are made up of one or more values, ranges of values, or categories of each of the topic, temporal and location attributes.

26. The event information processing method of processing event based information according to claim 25, wherein topical, temporal, and location selection criteria for event information distribution are augmented by correlated values of one or more of these attributes from topical, temporal, and location hierarchical sources.

27. The event information processing method of processing event based information according to claim 1, wherein location search criteria is set relative to a location defined by a global positioning system or other automated location determination.

28. The event information processing method of processing event based information according to claim 1, further comprising:
adding at least one subset of information to the displayable event based information, the subset of information being reflective of at least a portion of the search criteria.

29. The event information processing method of processing event based information according to claim 28, wherein additional subsets of information comprise at least one of a map, a graphic, an advertisement, a text message, video, hyperlink, and audio.

30. The event information processing method of processing event based information according to claim 1, wherein the event based information is displayable in a graphical user interface, the graphical user interface comprising:
a plurality of attribute windows, each of the plurality of attribute windows displaying event information reflective of one of topical, temporal, or location attribute search criteria; a primary window, the primary window displaying more detailed event information reflective of a single one of the plurality of attribute windows.

31. The event information processing method of processing event based information according to claim 1, wherein topical, temporal, and location selection criteria for event information display are set interactively by users.

32. The event information processing method of processing event based information according to claim 30, wherein
the topical attribute window is presented as an interactive list of topics;
the temporal attribute window is presented as at least one of an interactive calendar or clock; and
the location attribute window is presented as an interactive map or location graphic,
whereby user selections in each attribute window provide selection criteria for event information display.

33. The event information processing method of processing event based information according to claim 30, wherein selected event information is presented in:
the topical attribute window as a list of event links organized by topical hierarchy attribute;
the temporal attribute window as event links located on at least one of a calendar or clock representation by temporal attribute; and
the location attribute window as event links located on a location graphic of type and scale correlated with the location attribute from the location resource,
whereby event links are selectable to display event information

34. The event information processing method of processing event based information according to claim 1, wherein the acquired event information is stored in a database and the event attribute information is used to build database indices for access to the stored event information.

35. The event information processing method of processing event based information according to claim 31, wherein information on user selected events is gathered and organized by topical, temporal, and location attribute values of selected event information.

36. The event information processing method of processing event based information according to claim 1, wherein the acquired event based information is organized by one or more supplementary attributes according to predefined rules, said attributes used in place of or in addition to one or more of the topical, temporal, or location attributes for organization of and access to event information.
